(19) United States
(12) Patent Application Publication
(10) Pub. No.: US 2026/0167857 A1
(43) Pub. Date: Jun. 18, 2026

(54) CO2 FOAM FLUIDS FOR FRACTURING APPLICATIONS

(71) Applicants: CNPC USA Corporation, Houston, TX (US); Beijing Huamei, Inc., Beijing (CN); China National Petroleum Corporation, Beijing (CN)

(72) Inventors: Lijun Lin, Katy, TX (US); Xiangtong Yang, Beijing (CN); Shiling Zhang, Beijing (CN); Stephanie Yu, Cypress, TX (US)

(73) Assignees: CNPC USA Corporation, Houston, TX (US); Beijing Huamei, Inc., Beijing (CN); China National Petroleum Corporation, Beijing (CN)

(21) Appl. No.: 18/981,197

(22) Filed: Dec. 13, 2024

(51) Int. Cl. C09K 8/70; C09K 8/60; C09K 8/68; E21B 43/26

(52) U.S. Cl. CPC C09K 8/703; C09K 8/602; C09K 8/68; E21B 43/26; C09K 2208/12; C09K 2208/28

(57) ABSTRACT

A foamed fracturing fluid system for fracturing an oil and gas well during drilling operations includes a polyacrylamide friction reducer or a guar. The foamed fracturing fluid also includes a foaming agent that includes a mixture of surfactants. The mixture of surfactants include dodecyldimethylbetaine, myristylbetaine, and cetylbetaine. The foamed fracturing fluid is pumped into a wellbore of the oil and gas well for a fracturing operation.

### BACKGROUND

### 1. Field of Disclosure

Embodiments of the present disclosure relate to oil and gas fracturing fluid systems, and particularly, to foaming agents mixed with other base fluids to create foamed fracturing fluids.

### 2. Description of Related Art

Hydrocarbons such as oil and gas may be produced from wells that are drilled into hydrocarbon reservoirs. In order to increase production of oil and gas from a well, it is common for hydraulic fracturing techniques to be used, which typically involves injecting a fluid into the well at high pressures in order to create fractures in the underground rock formations surrounding the wellbore. Fracturing fluids can include one or more of: liquids (e.g., water or water-based polymers), solids (e.g., sand or ceramic materials), or gases (e.g., nitrogen or carbon dioxide). The fractures made from the fracturing process create pathways for oil and gas to flow out of the reservoir and into the wellbore in order to flow up to the surface when the wellbore pressure is reduced. Additionally, different substances may be added to fracturing fluids in order to increase oil and gas production in the well. For example, proppant may be added to the fracturing fluid, which are solids added to the liquid that function to keep the fractures open in the formation.

Some hydrocarbon formations can be sensitive to water, where formation damage can occur from interactions with water-based fracturing fluids. Furthermore, some oil and gas wells may be located in areas with a shortage of water. In these situations, among others, it may be beneficial to use a foamed fracturing fluid, particularly one with high foam quality, because using a foamed fracturing fluid can reduce the amount of water that needs to be used in the fracturing fluid and fracturing process itself. Foamed fracturing fluids comprise emulsions are a mixture of a substance, such as carbon dioxide, introduced in a super critical state phase and an aqueous liquid that forms an emulsion, which may commonly be referred to as a “foam” in the industry. The “foaming” in the liquid increases the volume of the fracturing fluid, thereby decreasing the amount of water required to produce the same amount of volume. Foamed fracturing fluid can have various advantages, such as increasing base fluid viscosity, which reduces the amount of viscosifying agent required and improving proppant transport. The foamed fracturing fluid also has a lower density than non-foamed fracturing fluids, which can aid in the recovery of the fluid itself during cleanup, thereby minimizing environmental impact. Moreover, foamed fracturing fluids can be more effective than non-foamed fracturing fluids in certain low-pressure reservoirs and other unconventional reservoirs, such as shale formations, where non-foamed fracturing fluids may not perform as well due to high fluid loss or other issues.

### SUMMARY

Applicants recognized the problems noted above herein and conceived and developed embodiments of systems and methods, according to the present disclosure, for foamed fracturing fluids.

In an embodiment, a foamed fracturing fluid includes a polyacrylamide friction reducer and a foaming agent. The foaming agent may be a surfactant mixture of one or more surfactants. In some embodiments, the surfactant mixture includes dodecyldimethylbetaine, myristylbetaine, and cetylbetaine. In one or more embodiments, the framed fracturing fluid further includes a clay stabilizer.

In another embodiment, a foamed fracturing fluid includes a guar and a foaming agent. The foaming agent may be a surfactant mixture of one or more surfactants. In some embodiments, the surfactant mixture includes dodecyldimethylbetaine, myristylbetaine, and cetylbetaine. In one or more embodiments, the framed fracturing fluid further includes a solution potassium chloride.

In an embodiment, a method of fracturing a well includes hydrating a polyacrylamide friction reducer in a solution comprising a clay stabilizer, to create a hydrated gel. In another embodiment, a method of fracturing a well includes hydrating a guar in a solution comprising a clay stabilizer, to create a hydrated gel. In some embodiments, methods of fracturing a well include hydrating a polyacrylamide friction reducer or a guar in a potassium chloride solution, to create a hydrated gel. In various embodiments, methods further include mixing a foaming agent with the hydrated gel to create a fracturing fluid. Methods also include introducing carbon dioxide to the fracturing fluid to create a foamed fracturing fluid. Furthermore, methods include pumping the foamed fracturing fluid into a wellbore of the well for a fracturing operation.

### BRIEF DESCRIPTION OF DRAWINGS

The present technology will be better understood on reading the following detailed description of non-limiting embodiments thereof, and on examining the accompanying drawings, in which:

FIG. 1 is a flow chart of a method for fracturing a well, in accordance with embodiments of the present disclosure;

FIG. 2 is a graph of viscosity and temperature over time of a foamed fracturing fluid that includes a foaming agent and a polyacrylamide friction reducer, in accordance with embodiments of the present disclosure; and

FIG. 3 is a graph of viscosity and temperature over time of a foamed fracturing fluid that includes a foaming agent and a hydroxypropyl guar, in accordance with embodiments of the present disclosure.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose. Additionally, like reference numerals may be used for like components, but such use should not be interpreted as limiting the disclosure.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Like numbers may be used to refer to like elements throughout, but it should be appreciated that using like numbers is for convenience and clarity and not intended to limit embodiments of the present disclosure. Moreover, references to “substantially” or “approximately” or “about” may refer to differences within ranges of +/−10 percent.

Embodiments of the present disclosure are directed toward a foaming agent for carbon dioxide (CO2) that may be used to create a foamed fracturing fluid system. In embodiments, various chemicals (e.g., “base fluids”) may be used to create the foamed fracturing fluid. In one or more embodiments, the base fluids may include a polyacrylamide friction reducer, a solution comprising a clay stabilizer, and a surfactant. In other embodiments, the base fluids may include a guar, a solution comprising a clay stabilizer, and a surfactant. In such other embodiments, the guar may be a hydroxypropyl guar (HPG) or a carboxymethyl hydroxypropyl guar (CMHPG). In various embodiments, the clay stabilizer is a potassium chloride (KCl) solution.

In one or more embodiments, the polyacrylamide friction reducer may be FLOJET DR 53225 (“FDR 53225”) and obtained from SNF Inc. FDR 53225 may be an emulsion product. In other embodiments, the guar may be a HPG, such as TIGUAR HP8FF, an HPG obtained from Solvay USA LLC (Syensqo). In various embodiments, the clay stabilizer may be a KCl solution used in the base fluids for making the foamed fracturing fluid. In embodiments, the KCl solution is approximately a 2% solution of KCl, however, it should be appreciated that higher or lower concentration solutions of KCl may be used as a base fluid as well. For example, a 4% solution of KCl and a 6% solution of KCl are also suitable as a clay stabilizer. Additionally, it should be appreciated that KCl may be employed as a base fluid to make the foamed fracturing fluid because it is compatible with most drilling fluid additives and can stabilize water-sensitive clays and shales. However, there are other substances besides KCl that are suitable as clay stabilizers in the foamed fracturing fluids, such as choline chloride or ammonium tetramethyl chloride. Ammonium tetramethyl chloride may work as a clay stabilizer for base fluids comprising the guar, or guar derivatives; for base fluids comprising polyacrylamide, the ammonium tetramethyl chloride may reduce the viscosity of the fluid by some degree.

It should be appreciated that the surfactant may be a single surfactant or a mixture or combination of two or more surfactants. In some embodiments, a surfactant used may be dodecyldimethylbetaine. The Chemical Abstracts Service (CAS) number of dodecyldimethylbetaine is CAS #683-10-3, and the chemical structure of dodecyldimethylbetaine is illustrated by the following structural formula diagram:

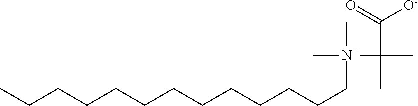 [SMILES: CCCCCCCCCCCCC[N+](C)(C)C(C)(C)C(=O)[O-]]

In one or more embodiments, another surfactant used may be myristylbetaine. The CAS number of myristylbetaine is CAS #2601-33-4, and the chemical structure of myristylbetaine is illustrated by the following structural formula diagram:

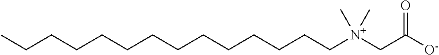 [SMILES: CCCCCCCCCCCCCC[N+](C)(C)CC(=O)[O-]]

In various embodiments, yet another surfactant used may be cetylbetaine. The CAS number of cetylbetaine is CAS #693-33-4, and the chemical structure of cetylbetaine is illustrated by the following structural formula diagram:

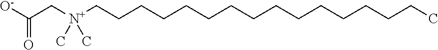 [SMILES: CCCCCCCCCCCCCCCC[N+](C)(C)CC(=O)[O-]]

In some embodiments, the surfactant may be made of dodecyldimethylbetaine, myristylbetaine, and cetylbetaine, all in combination. This combined surfactant is sold in the United States as PETROSTEP B-1235 by Stepan Company. In an embodiment, the composition of the combined surfactant may be approximately 20% to approximately 30% dodecyldimethylbetaine, approximately 10% to approximately 20% myristylbetaine, and approximately 1% to approximately 3% cetylbetaine. However, it should be appreciated that the compositions of the individual surfactant components in the combined surfactant may be altered to be substantially lower or substantially higher than these exemplary ranges of percentages.

In one or more embodiments, the particular surfactants selected to be included in the base fluids may influence various properties of the foamed fracturing fluids system. Surfactants selected may influence the viscosity, foam quality, stability, temperature resistance, and other properties of the foamed fracturing fluid. Foam quality may be measured by the volume percent of gas in the total foamed fluid. It may be preferable for the foamed fracturing fluid to exhibit high foam quality and remain stable for periods of approximately 2 hours or more, but depends on the fracturing operation and desired outcome.

Typically, either the polyacrylamide friction reducer or the HPG will be included in the base fluids for the foamed fracturing fluid system. It should be appreciated that selecting the polyacrylamide friction reducer versus selecting the HPG for inclusion in the fracturing fluid may influence the properties of the fracturing fluid. The foaming agent may be used with the polyacrylamide friction reducer to form a foamed slickwater fracturing fluid system. Slickwater fracturing fluids may have a lower viscosity than other fracturing fluids and may be particularly useful in unconventional oil and gas reservoirs, such as shale formations. However, fracturing fluids with a polyacrylamide friction reducer may be sensitive to high temperature and high salinity in a formation. The foaming agent may be used with the HPG to create a higher viscosity fracturing fluid. Fracturing fluids containing HPG may also have good temperature stability at high temperature and may also leave less residue after the fracturing operation and cause less environmental concerns. However, fracturing fluids with HPG may not be suitable for sensitive formations, such as shale formations.

In various embodiments, methods may include fracturing an oil and gas well using a foamed fracturing fluid. The foamed fracturing fluid may be pumped downhole into an oil and gas reservoir through a wellbore. The foamed fracturing fluid may be pumped at high rates in order to generate narrow and complex fractures in the rock of the formation. In one or more embodiments, methods may include creating a hydrated gel by hydrating a polyacrylamide friction reducer or a HPG, or both. A hydrated gel in this context is generally understood as when the polymer fully swells in water, reaching or approaching a maximum viscosity, and ready for use as a fracturing fluid. Methods may also include mixing a foaming agent (such as a surfactant, or a combination or mixture of surfactants) with the hydrated gel in order to create a fracturing fluid. In some embodiments, methods may include pumping the fracturing fluid without the introduction of a gas.

Methods may further include introducing a substance in a super critical state phase to the fracturing fluid to form a foamed fracturing fluid, once the fracturing fluid has reached homogeneity. Components of the fracturing fluid may be mixed in a blender, or another suitable means of adequately mixing the components. In one or more embodiments, the substance in the super critical state phase that is introduced may be super critical CO2, however, in some embodiments, the substance in a super critical state phase that is introduced may be nitrogen, a mixture of nitrogen and CO2, or any other suitable substance in a super critical state phase or a gas phase, or a mixture thereof. CO2 may be introduced to the hydrated gel of the fracturing fluid in a foam generator. In the foam generator, the hydrated gel may turbulently admix with the CO2, whereby vigorous contact between the super critical or gaseous CO2 and the gel creates a stable foam. In some embodiments, methods may include pressurizing the fracturing fluid or the foamed fracturing fluid using a pump or other means. In various embodiments, methods may include pumping the foamed fracturing fluid downhole to an oil and gas reservoir in a formation, through a wellbore, and fracturing the formation. The pumping of the foamed fracturing fluid may be performed using a high pressure pump. Methods may also include reducing the pressure of the fluids pumped into the wellbore, inducing the oil and gas to flow out of the reservoir toward the wellbore. Methods may further include extracting oil and gas from the wellbore as the oil and gas rises to the surface.

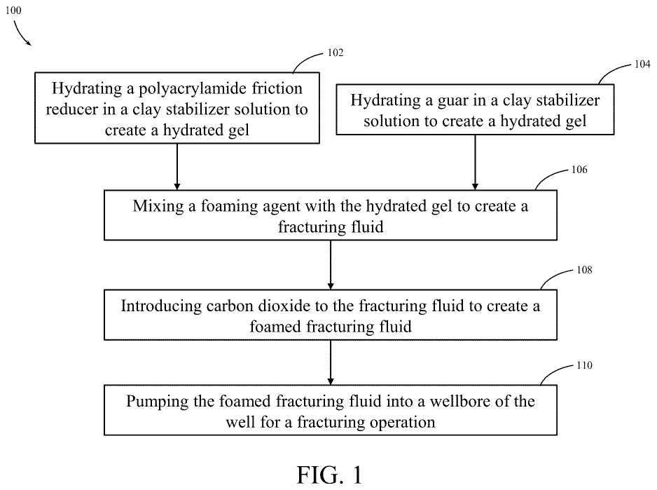

FIG. 1 is a flow chart of a method 100 for fracturing a well during oil and gas drilling operations. It should be appreciated that steps for the method may be performed in any order, or in parallel, unless otherwise specifically stated. Moreover, the method may include more or fewer steps. In an embodiment, the method 100 includes hydrating a polyacrylamide friction reducer in a solution comprising a clay stabilizer, to create a hydrated gel 102. Alternatively, in another embodiment, the method 100 includes hydrating a guar in a solution comprising a clay stabilizer, to create a hydrated gel 104. In embodiments of the present disclosure, the method 100 may also include mixing a foaming agent with the hydrated gel to create a fracturing fluid 106. Further, the method 100 may include introducing carbon dioxide to the fracturing fluid to create a foamed fracturing fluid 108. The method 100 may also include pumping the foamed fracturing fluid into a wellbore of the well for a fracturing operation 110.

### EXAMPLES

The following examples are non-limiting exemplary embodiments and not meant to limit the scope of the disclosure.

### Example 1

Polyacrylamide friction reducer FDR 53225 and foaming agent surfactant PETROSTEP B-1235 were hydrated in 2 wt % KCl for approximately 30 minutes using an overhead mixer. The surfactant or foaming agent (5 gpt or 0.5 vol %) was added into the hydrated gel and mixed for approximately 3 minutes. After mixing with the surfactant, the gel fluid was centrifuged to remove entrained gas. High temperature foam rheology tests were then performed on a recirculating loop foam rheometer. CO2 was directly introduced to the foam rheometer to create a CO2 foamed fracturing fluid (e.g., the “foam”). The foamed fracturing fluid viscosities were then measured at a shear rate of 100 s⁻¹ and in shear ramps of 75, 50, 25, 50, and 75 s⁻¹ approximately every 30 min.

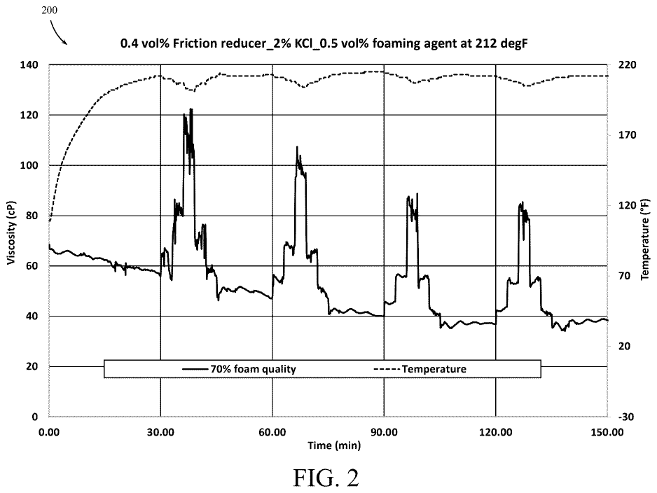

FIG. 2 illustrates a graph of viscosity (in centipoise, or cP) over time (in minutes) of the foamed fracturing fluid comprising the polyacrylamide friction reducer at 70% foam quality, represented by the solid line. FIG. 2 also illustrates the temperature (in degrees Fahrenheit) over time (in minutes), represented by the dashed line. As can be seen from the graph, the foaming agent can create a stable CO2 foam with polyacrylamide friction reducer at high foam qualities of 70%. With very low concentration of the polyacrylamide friction reducer at 0.4 vol % and no temperature stabilizer, the foam were able to remain stable for over 2.5 hours at 212 degrees Fahrenheit.

As can be seen in FIG. 2, the viscosity graph shows various peaks. This corresponds with the four different shear ramping processes that occurred every 30 minutes. The shear ramping process included starting at a shear rate of 100 s⁻¹, then ramping to a shear rate of 75 s⁻¹, then to 50 s⁻¹, then to 25 s⁻¹, back down to 50 s⁻¹, down to 75 s⁻¹, and ultimately to the original shear rate of 100 s⁻¹. This shear ramping can be seen in FIG. 2, as the “base” of each peak (i.e., the lowest plateaus of the graph; i.e., the lower viscosity values) represents 100 s⁻¹, the shear rate applied to the foam initially. Each subsequent plateau represents the next shear rate being applied to the foam in the shear ramping process.

### Example 2

Hydroxypropyl guar TIGUAR HP8FF and foaming agent surfactant PETROSTEP B-1235 were hydrated in 2 wt % KCl for approximately 30 minutes using an overhead mixer. The surfactant or foaming agent (5 gpt or 0.5 vol %) was added into the hydrated gel and mixed for approximately 3 minutes. After mixing with the surfactant, the gel fluid was centrifuged to remove entrained gas. High temperature foam rheology tests were then performed on a recirculating loop foam rheometer. CO2 was directly introduced to the foam rheometer to create a CO2 foamed fracturing fluid. The foamed fracturing fluid viscosities were then measured at a shear rate of 100 s⁻¹ and in shear ramps of 75, 50, 25, 50, and 75 s⁻¹ approximately every 30 min.

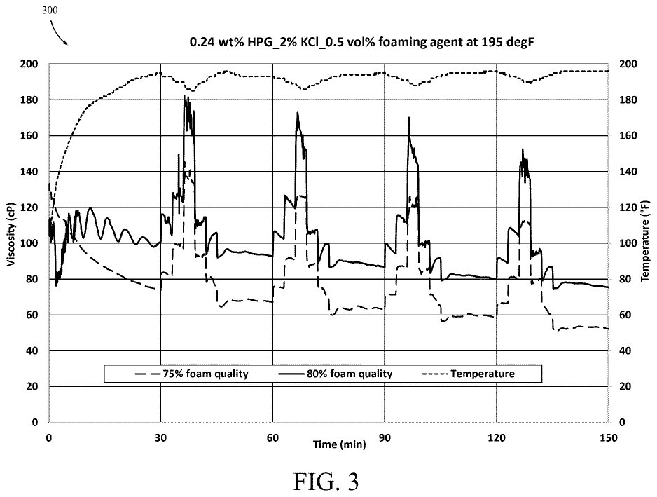

FIG. 3 illustrates a graph of viscosity (in centipoise, or cP) over time (in minutes) of the foamed fracturing fluid comprising the HPG at both 75% and 80% foam quality, represented by the long-dashed line and the solid line, respectively. FIG. 3 also illustrates the temperature (in degrees Fahrenheit) over time (in minutes), represented by the short-dashed line. As can be seen from the graph, the foaming agent can create stable CO2 foams with HPG, both at a high foam quality of 75%, and at a foam quality of 80%. Both foams comprised 0.24 wt % HPG. Even with no temperature stabilizer added, the foams were able to remain stable for over 2.5 hours at 195 degrees Fahrenheit. As can be deduced from the results, Example 2 was able to achieve higher foam quality (i.e., foam qualities of 75% and 80%) compared to Example 1 (i.e., foam quality of 70%). This discrepancy may be due to the chemical structure of the HPG causing the HPG to be better than the polyacrylamide friction reducer at stabilizing the bubbles in the foam.

As similarly described above with respect to Example 1 and FIG. 2, the viscosity graph of FIG. 3 shows various peaks for both the 75% foam quality line and the 80% foam quality line. This corresponds with the four different shear ramping processes that occurred every 30 minutes. The shear ramping process included starting at a shear rate of 100 s⁻¹, then ramping to a shear rate of 75 s⁻¹, then to 50 s⁻¹, then to 25 s⁻¹, back down to 50 s⁻¹, down to 75 s⁻¹, and ultimately to the original shear rate of 100 s⁻¹. This shear ramping can be seen in FIG. 3, as the “base” of each peak of each respective foam quality line on the graph (i.e., the lowest plateaus of the graph; i.e., the lower viscosity values) represents 100 s⁻¹, the shear rate applied to the foam initially. Each subsequent plateau represents the next shear rate being applied to the foam in the shear ramping process.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

1. A foamed fracturing fluid system, comprising:
a polyacrylamide friction reducer; and
a foaming agent comprising a surfactant mixture, wherein the surfactant mixture comprises:
dodecyldimethylbetaine;
myristylbetaine; and
cetylbetaine.

2. The foamed fracturing fluid system of claim 1, further comprising:
a clay stabilizer.

3. The foamed fracturing fluid system of claim 2, wherein the clay stabilizer is a potassium chloride solution comprising approximately 2 wt % potassium chloride.

4. The foamed fracturing fluid system of claim 1, wherein the dodecyldimethylbetaine comprises approximately 20% to approximately 30% of the surfactant mixture.

5. The foamed fracturing fluid system of claim 4, wherein the myristylbetaine comprises approximately 10% to approximately 20% of the surfactant mixture.

6. The foamed fracturing fluid system of claim 5, wherein the cetylbetaine comprises approximately 1% to approximately 3% of the surfactant mixture.

7. The foamed fracturing fluid system of claim 1, wherein the foaming agent comprises approximately 0.1 vol % to approximately 1.0 vol % of the foamed fracturing fluid.

8. A foamed fracturing fluid system, comprising:
a guar; and
a foaming agent comprising a surfactant mixture, wherein the surfactant mixture comprises:
dodecyldimethylbetaine;
myristylbetaine; and
cetylbetaine.

9. The foamed fracturing fluid system of claim 8, further comprising:
a clay stabilizer.

10. The foamed fracturing fluid system of claim 9, wherein the potassium chloride is approximately a 2 wt % potassium chloride solution.

11. The foamed fracturing fluid system of claim 8, wherein the dodecyldimethylbetaine comprises approximately 20% to approximately 30% of the surfactant mixture.

12. The foamed fracturing fluid system of claim 11, wherein the myristylbetaine comprises approximately 10% to approximately 20% of the surfactant mixture.

13. The foamed fracturing fluid system of claim 12, wherein the cetylbetaine comprises approximately 1% to approximately 3% of the surfactant mixture.

14. The foamed fracturing fluid system of claim 8, wherein the foaming agent comprises approximately 0.1 vol % to approximately 1.0 vol % of the foamed fracturing fluid.

15. The foamed fracturing fluid system of claim 8, wherein the guar is a hydroxypropyl guar.

16. The foamed fracturing fluid system of claim 8, wherein the guar is a carboxymethyl hydroxypropyl guar.

17. A method of fracturing a well, comprising:
hydrating a polyacrylamide friction reducer or a guar in a solution comprising a clay stabilizer, to create a hydrated gel;
mixing a foaming agent with the hydrated gel to create a fracturing fluid;
introducing carbon dioxide to the fracturing fluid to create a foamed fracturing fluid; and
pumping the foamed fracturing fluid into a wellbore of the well for a fracturing operation.

18. The method of claim 17, wherein the foaming agent comprises:
dodecyldimethylbetaine;
myristylbetaine; and
cetylbetaine.

19. The method of claim 17, wherein the foaming agent comprises approximately 0.1 vol % to approximately 1.0 vol % of the foamed fracturing fluid.

20. The method of claim 17, wherein the guar is a hydroxypropyl guar (HPG) or a carboxymethyl hydroxypropyl guar (CMHPG).
